(19) United States
(12) Patent Application Publication
(10) Pub. No.: US 2026/0221342 A1
(43) Pub. Date: Jul. 30, 2026

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventor: Kaito SAKAI, Takasaki-shi (JP)

(21) Appl. No.: 19/421,534

(22) Filed: Dec. 16, 2025

(30) Foreign Application Priority Data
Jan. 27, 2025 (JP) 2025-011278

(51) Int. Cl. H01G 4/12; H01G 4/232; H01G 4/258; H01G 4/30

(52) U.S. Cl. CPC H01G 4/1281; H01G 4/232; H01G 4/258; H01G 4/30

(57) ABSTRACT

A multilayer ceramic electronic device includes a dielectric layer including a first dielectric grain having a first core containing bismuth, sodium, and titanium as a main component and a first shell provided outside of the first core, and a second dielectric grain having a second core containing sodium and niobium as a main component and a second shell provided outside of the second core, a plurality of internal electrodes facing each other and sandwiching the dielectric layer, and external electrodes electrically connected to the plurality of internal electrodes respectively.

### CROSS-REFERENCE TO RELATED APPLICATION

This application is based upon and claims the benefit of priority of the prior Japanese Patent Application No. 2025-011278, filed on Jan. 27, 2025, the entire contents of which are incorporated herein by reference.

### FIELD

A certain aspect of the present disclosure relates to a multilayer ceramic electronic device and a dielectric ceramic composition.

### BACKGROUND

In recent years, the increasing density of electronic circuits has led to a strong demand for smaller, more reliable dielectric elements. Multilayer ceramic electronic devices such as multilayer ceramic capacitors have rapidly become smaller, have larger capacities, and are more reliable, and their applications are expanding. Accordingly, a variety of properties are required. Dielectric ceramic compositions containing barium titanate (BaTiO₃) as their main component are commonly used.

### SUMMARY OF THE INVENTION

According to an aspect of the embodiments, there is provided a multilayer ceramic electronic device including: a dielectric layer including: a first dielectric grain having a first core containing bismuth, sodium, and titanium as a main component and a first shell provided outside of the first core; and a second dielectric grain having a second core containing sodium and niobium as a main component and a second shell provided outside of the second core; a plurality of internal electrodes facing each other and sandwiching the dielectric layer; and external electrodes electrically connected to the plurality of internal electrodes respectively.

According to another aspect of the embodiments, there is provided a dielectric ceramic composition including: a first dielectric grain having a first core containing bismuth, sodium, and titanium as a main component and a first shell provided outside of the first core; and a second dielectric grain having a second core containing sodium and niobium as a main component and a second shell provided outside of the second core.

According to another aspect of the embodiments, there is provided a dielectric ceramic composition including: a first dielectric grain having a first core and a first shell provided outside of the first core; and a second dielectric grain having a different constituent component from the first core and a second shell provided outside of the second core.

### BRIEF DESCRIPTION OF THE DRAWINGS

FIG. 1 illustrates a dielectric ceramic composition;

FIG. 2 is a partial cross-sectional perspective view of a multilayer ceramic capacitor;

FIG. 3 is a cross-sectional view taken along line A-A in FIG. 2;

FIG. 4 is a cross-sectional view taken along line B-B in FIG. 2;

FIG. 5 illustrates a schematic cross sectional view of a dielectric layer;

FIG. 6 illustrates a flow of a manufacturing method of a multilayer ceramic capacitor;

FIG. 7A and FIG. 7B illustrate a printing process; and

FIG. 8 illustrates a crimping process.

### DETAILED DESCRIPTION

For example, capacitors for automobiles and industrial equipment are often used in places where a high DC bias of several hundred volts is applied, such as in stable power supplies, motor drive controls, and power conversion devices. For this reason, the dielectric ceramic composition used in these multilayer ceramic electronic devices is required to have a high relative permittivity when a high DC bias is applied.

Furthermore, multilayer ceramic electronic devices are used in many electronic devices due to their high reliability and low cost. In recent years, there has been a trend toward high-temperature guarantees for electronic devices used in automobiles. Therefore, specific temperature characteristics are required.

As such, multilayer ceramic electronic devices are required to have several different characteristics.

Hereinafter, an exemplary embodiment will be described with reference to the accompanying drawings.

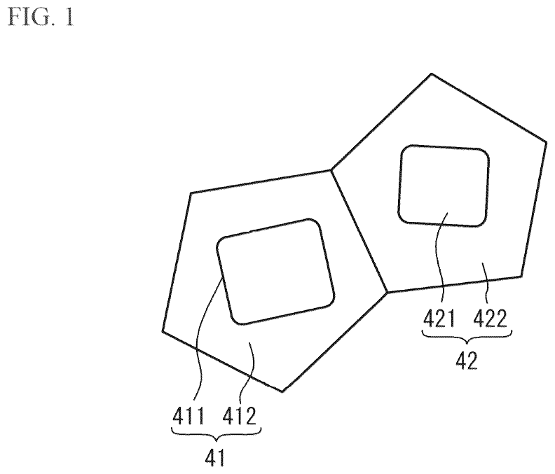

(First Embodiment) The dielectric ceramic composition according to the first embodiment is a ceramic polycrystalline body containing crystal grains, as illustrated in FIG. 1. Of these ceramic polycrystalline bodies, at least one is a first dielectric grain 41 having a core-shell structure, and at least one is a second dielectric grain 42 having another core-shell structure.

The first dielectric grain 41 has a first core 411 and a first shell 412 disposed on the outside of the first core 411. The second dielectric grain 42 has a second core 421 having a different constituent component from the first core 411, and a second shell 422 disposed on the outside of the second core 421.

Because the constituent components of the second core 421 differ from those of the first core 411, the characteristics realized by the first core 411 and the characteristics realized by the second core 421 are obtained. This allows for a plurality of different characteristics to be obtained.

For example, the lattice constant of the first core 411 differs from the lattice constant of the second core 421. In this case, epitaxial strain is introduced at the core-shell interface between the first core 411 and the first shell 412 and at the core-shell interface between the second core 421 and the second shell 422. As a result, the polarization directions of the first core 411 and the second core 421 become less likely to align while maintaining their respective crystal structures, making it possible to satisfy specified temperature characteristics while maintaining a high relative dielectric constant when a DC bias is applied.

For example, the dielectric ceramic composition of this embodiment can satisfy the temperature characteristics of X8R, which has a capacitance change rate of within 15% when a DC bias of 15 V/μm is applied, and a capacitance change rate of ±15% or less in the temperature range of −55° C. to 150° C.

For example, if the first core 411 and the second core 421 are primarily composed of a ceramic having a perovskite structure represented by the general formula ABO₃, the constituent components of the A site and B site of the first core 411 are at least partially different from the constituent components of the A site and B site of the second core 421. Note that this perovskite structure includes ABO_{3-α}, which deviates from the stoichiometric composition.

The constituent components of the first shell 412 and the second shell 422 may be different or the same.

For example, the first core 411 primarily contains bismuth, sodium, and titanium. The second core 421 primarily contains sodium and niobium. For example, the total content of bismuth, sodium, and titanium in the first core 411 is 80 at % or more, and the total content of sodium and niobium in the second core 421 is 80 at % or more.

For example, the first core 411 is primarily composed of (BiₐNa_{b})Ti_{c}O₃, a perovskite containing bismuth and sodium in the A site and titanium in the B site. For example, the first core 411 contains 80 at % or more of (BiₐNa_{b})Ti_{c}O₃. For example, the (BiₐNa_{b})Ti_{c}O₃ of the first core 411 is (Bi_{0.5}Na_{0.5})TiO₃.

For example, the second core 421 is primarily composed of Na_{d}NbₑO₃, a perovskite containing sodium in the A site and niobium in the B site. For example, the second core 421 contains 80 at % or more of Na_{d}NbₑO₃. For example, the Na_{d}NbₑO₃ of the second core 421 is NaNbO₃.

The first shell 412 and the second shell 422 are not particularly limited as long as they are ceramic. For example, if the first core 411 is (BiₐNa_{b})Ti_{c}O₃ and the second core 421 is Na_{d}NbₑO₃, the ceramic may be primarily composed of bismuth, sodium, titanium, and niobium. For example, the first shell 412 and the second shell 422 may be primarily composed of (Bi_{f}Na_{g})(TiₕNbᵢ)O₃, a perovskite containing bismuth and sodium in the A site and titanium and niobium in the B site. The values of f to i in the first shell 412 and the second shell 422 may be different or the same.

For example, the first shell 412 and the second shell 422 contain 90 at % or more of (Bi_{f}Na_{g})(TiₕNbᵢ)O₃. For example, in (Bi_{f}Na_{g})(TiₕNbᵢ)O₃, f is 0.22 or greater and 0.43 or less, g is 0.57 or greater and 0.78 or less, i is 0.44 or greater and 0.85 or less, and j is 0.15 or greater and 0.56 or less.

For example, in the first shell 412 and the second shell 422, (Bi_{f}Na_{g})(TiₕNbᵢ)O₃ can take the form of (Bi_{0.4}Na_{0.6})(Ti_{0.8}Nb_{0.2})O₃, (Bi_{0.3}Na_{0.7})(Ti_{0.6}Nb_{0.4})O₃, (Bi_{0.25}Na_{0.75})(Ti_{0.5}Nb_{0.5})O₃, or the like.

In the dielectric ceramic composition according to this embodiment, if the content of either the first dielectric grains 41 or the second dielectric grains 42 is too low, the effects obtained by including both the first dielectric grain 41 and the second dielectric grain 42 may not be fully achieved. Therefore, it is preferable to set a lower and upper limit for the content of the first dielectric grains 41 and the second dielectric grains 42. In this embodiment, when the average abundance ratio of the first dielectric grains 41 is α and the average abundance ratio of the second dielectric particles 42 is β, it is preferable that the following relationships are satisfied: 0.05≤α≤0.35 and 0.05≤β≤0.35; it is preferable that the following relationships are satisfied: 0.05≤α≤0.35, 0.05≤β≤0.35 and 0.1<α+β≤0.70; and it is even more preferable that the following relationships are satisfied: 0.092<α<0.348, 0.115<β<0.333, and 0.247<α+β<0.637.

Here, the average abundance ratio refers to the ratio of the number of first dielectric grains 41 and second dielectric grains 42 to the total number of first dielectric grains 41 and second dielectric grains 42 in a given area of the cross section of the dielectric ceramic composition. For example, when an image of the cross section of the dielectric ceramic composition is taken with a field emission scanning electron microscope so that 200 to 400 dielectric grains are visible within the field of view, the average abundance ratio of the first dielectric grains 41 can be defined as a, and the average abundance ratio of the second dielectric grains 42 can be defined as B.

For example, if the content of either niobium or titanium in the dielectric ceramic composition is too low, the effects achieved by including both the first dielectric grain 41 and the second dielectric grain 42 may not be fully achieved. Therefore, it is preferable to set lower and upper limits for the element ratio of titanium to niobium, Ti/Nb=X, in the dielectric ceramic composition. In this embodiment, it is preferable to satisfy the relationship 0.8≤X≤5.7.

(Second Embodiment) In the second embodiment, a multilayer ceramic capacitor 100 using the dielectric ceramic composition of the first embodiment will be described.

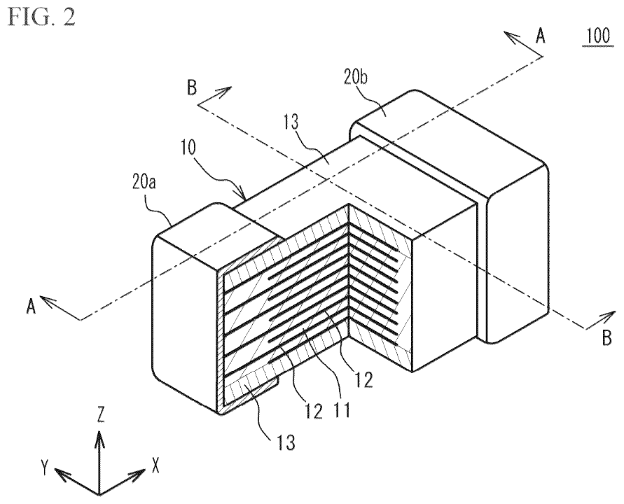

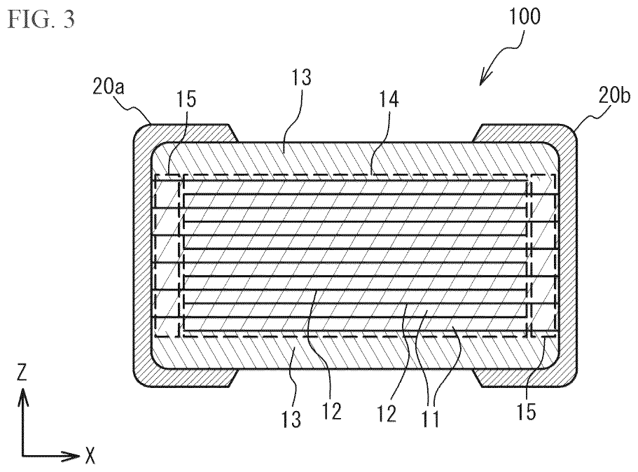

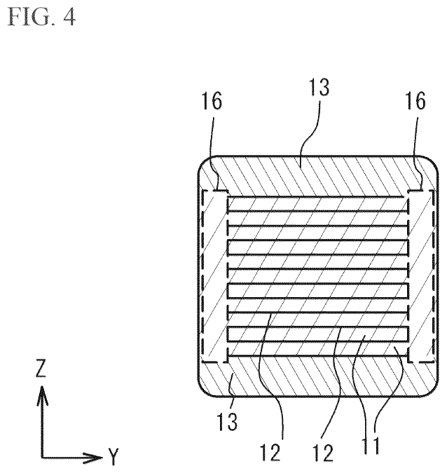

FIG. 2 illustrates a perspective view of the multilayer ceramic capacitor 100, in which a cross section of a part of the multilayer ceramic capacitor 100 is illustrated. FIG. 3 is a cross-sectional view taken along line A-A in FIG. 2. FIG. 4 is a cross-sectional view taken along line B-B in FIG. 2. As illustrated in FIG. 2 to FIG. 4, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

The multilayer chip 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used.

As illustrated in FIG. 3, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 4, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

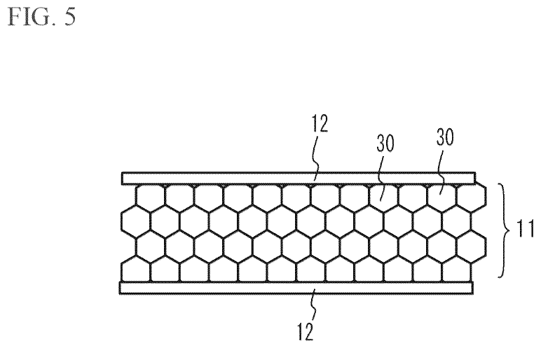

FIG. 5 is a schematic cross-sectional view of the dielectric layer 11. As illustrated in FIG. 5, the dielectric layer 11 has a structure in which a plurality of dielectric grains 30 constituting the main phase are sintered. For example, the dielectric layer 11 may have a single dielectric grain 30 in the thickness direction, or may have a structure in which the plurality of dielectric grains 30 are connected via grain boundaries, as illustrated in FIG. 5. Some of the plurality of dielectric grains 30 are the first dielectric grains 41 described above, and others are the second dielectric grains 42 described above.

In the multilayer ceramic capacitor 100 according to this embodiment, at least a portion of the dielectric layer 11 in the capacity section 14 contains the dielectric ceramic composition illustrated in FIG. 1. This allows the specified temperature characteristics to be satisfied while maintaining a high relative dielectric constant when a DC bias is applied. For example, the multilayer ceramic capacitor 100 according to this embodiment can satisfy the temperature characteristics of X8R, in which the rate of change when a DC bias of 15 V/μm is applied is within 15%, and the rate of change of capacitance in the temperature range of −55° C. to 150° C. is within ±15%.

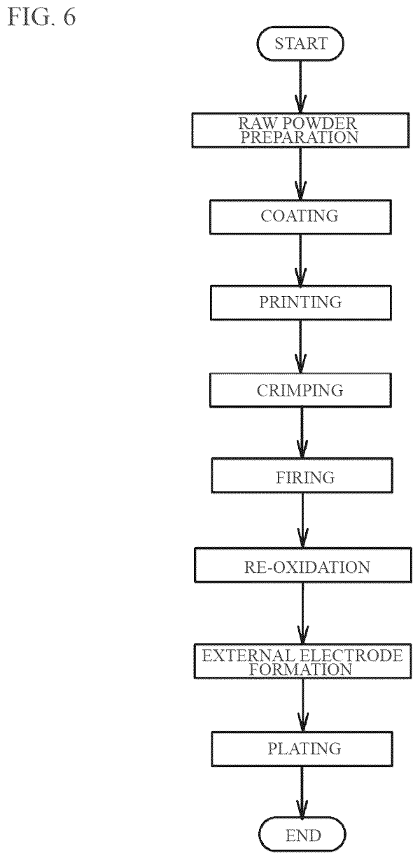

Next, a description will be given of a manufacturing method of the multilayer ceramic capacitors 100. FIG. 6 illustrates a manufacturing method of the multilayer ceramic capacitor 100.

(Raw Powder Preparation Process) First, a dielectric ceramic composition for forming the dielectric layer 11 is prepared. Oxide raw materials for bismuth, sodium, titanium, and niobium are prepared as starting materials. The bismuth, sodium, and titanium starting materials, and the sodium and niobium starting materials, are weighed separately and subjected to wet ball milling using ethanol and zirconia beads to produce a raw material mixture. The resulting raw material mixture is calcined at a temperature range of 700° C. to 950° C. for 30 minutes to 5 hours. The calcined powders are then weighed and mixed in desired proportions, and a binder such as polyvinyl butyral (PVB) resin, an organic solvent such as ethanol or toluene, and a plasticizer are added and wet-mixed.

(Coating process) The resulting slurry is applied to a substrate, for example, by a die coater method or a doctor blade method, to form a ceramic green sheet 51, which is then dried. The substrate is, for example, a polyethylene terephthalate (PET) film. An illustration illustrating the coating process is omitted.

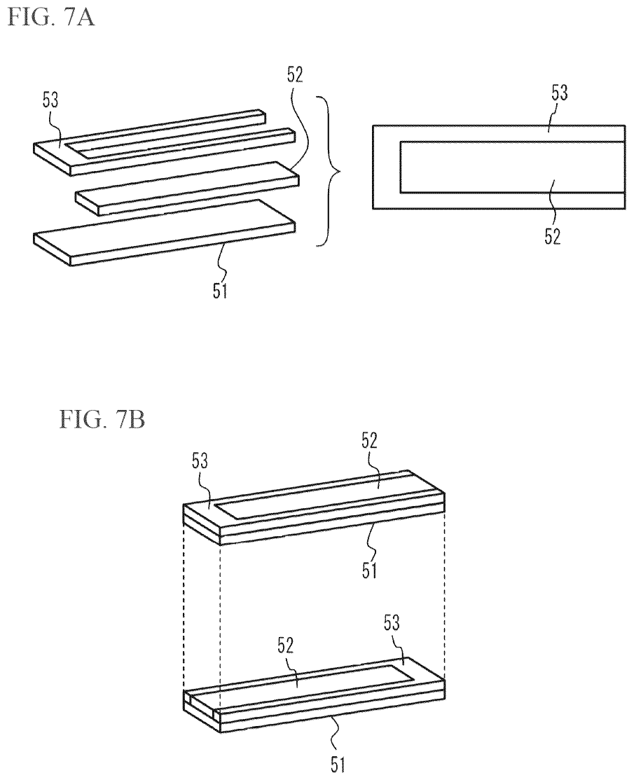

(Printing process) Next, as illustrated in FIG. 7A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material.

As illustrated in FIG. 7A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 7B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 10 to 50.

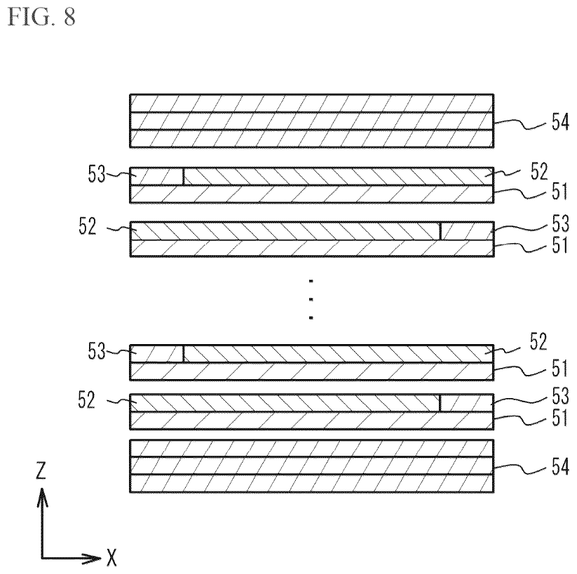

(Crimping process) As illustrated in FIG. 8, a predetermined number of cover sheets 54 (for example, 2 to 10 layers) are stacked on the top and bottom of the multilayer body in which the stack units are stacked, and then thermocompression bonded. As an example, the above-mentioned dielectric ceramic composition can be used as the ceramic material for the cover sheets 54. Then, the multilayer body is cut to a predetermined chip size (for example, 1.0 mm×0.5 mm).

(Firing process) The ceramic multilayer body thus obtained is subjected to a binder removal process in an N₂ atmosphere, air atmosphere, or the like, and then a metal paste that will become the base layer of the external electrodes 20a, 20b is applied by dipping, and the resulting mixture is kept at 800° C. to 1100° C. for 10 minutes to 1 hour in a reducing atmosphere with an oxygen partial pressure of 10-10 to 10-7 atm, and then fired at 1150° C. to 1300° C. for 10 minutes to 2 hours. In this way, the multilayer ceramic capacitor 100 is obtained.

(Re-oxidation process) Thereafter, a re-oxidation process may be performed in an N₂ gas atmosphere at 600 to 1000° C. With the processes, the multilayer chip 10 is fabricated.

(External electrode formation process) Next, a metal paste containing the metal for the base layer of the external electrodes 20a and 20b is applied to the two end faces of the multilayer chip 10 obtained in this manner by dipping and then baked.

(Plating process) After that, metal layers such as copper, nickel, and tin may be formed on the base layer by plating. Thus, the multilayer ceramic capacitor 100 is manufactured.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Examples

(Examples 1 to 11) Oxide raw materials for bismuth, sodium, titanium, and niobium were prepared as starting materials. The bismuth, sodium, and titanium starting materials, and the sodium and niobium starting materials, were weighed separately and then subjected to wet ball milling using ethanol and zirconia beads to produce a raw material mixture. The resulting raw material mixture was then calcined at a temperature range of 700° C. to 950° C. for 30 minutes to 5 hours. The calcined powders were weighed and mixed in desired proportions, and then wet-mixed with a binder such as polyvinyl butyral (PVB) resin, an organic solvent such as ethanol or toluene, and a plasticizer. The resulting slurry was used to coat and dry ceramic green sheets on a substrate. A polyethylene terephthalate (PET) film was used as the substrate. A metal conductive paste containing an organic binder for forming the internal electrodes was printed on the surface of the ceramic green sheets using screen printing or other methods to form the internal electrode patterns. A silver-palladium alloy was used for the metal conductive paste. The stack units were stacked so that the internal electrode layers and the dielectric layers alternated, with the edges of the internal electrode layers alternately exposed at both longitudinal end faces of the dielectric layers and alternately drawn to a pair of external electrodes with opposite polarities. For example, the internal electrode pattern had 10 layers. predetermined number of cover sheets were stacked on top and bottom of the multilayer body of stack units and thermocompression-bonded. The resulting ceramic multilayer body was de-bindered in a N₂ atmosphere and then fired in air at temperatures ranging from 800° C. to 1150° C. for 5 minutes to 10 hours. The electrode paste was applied to the ends by dipping, and the DC bias characteristics of the dielectric constant and the high-temperature load life were measured. The composition of each component after firing was analyzed using inductively coupled plasma mass spectrometry (ICP-MS). Sodium was quantitatively evaluated using ICP atomic emission spectrometry (ICP-AES).

Table 1 summarizes the properties of Examples 1 to 7 and Comparative Examples 1 to 4. “γ” is “α+β”. In Examples 1 to 11, the first core 411 was Bi_{0.5}Na_{0.5}TiO₃, and the second core 421 was NaNbO₃.

TABLE 1

| | | | | | | | | DC | | | | | |
|---|---|---|---|---|---|---|---|---|---|---|---|---|---|
| | | | | SUB- | | | | BIAS | | CHANGE | | TEMPERATURE | |
| | | | | COMPONENT | | | | CHARACTER- | | RATE (%) | | CHARACTER- | OVERALL |
| EXAMPLE | α | β | γ | TYPE | mol % | ε1 | ε2 | ISTICS | JUDGE | MIN | MAX | ISTICS | JUDGE |
| 1 | 0.325 | 0.312 | 0.637 | Bi | 2 | 894 | 768 | −14.1 | ◯ | −6.1 | 12 | ◯ | ◯ |
| 2 | 0.152 | 0.169 | 0.321 | Bi | 2 | 935 | 808 | −13.6 | ⊚ | −6.6 | 8.11 | ⊚ | ⊚ |
| 3 | 0.117 | 0.13 | 0.247 | Bi | 2 | 935 | 810 | −13.4 | ⊚ | −6.4 | 7.2 | ⊚ | ⊚ |
| 4 | 0.315 | 0.162 | 0.477 | La | 2 | 842 | 758 | −10 | ⊚ | −6.6 | 0.79 | ⊚ | ⊚ |
| 5 | 0.181 | 0.231 | 0.412 | La | 2 | 883 | 788 | −10.8 | ⊚ | −7.4 | 0.75 | ⊚ | ⊚ |
| 6 | 0.348 | 0.115 | 0.463 | — | — | 1173 | 1004 | −14.4 | ◯ | −9.9 | 14.5 | ◯ | ◯ |
| 7 | 0.092 | 0.333 | 0.425 | — | — | 506 | 461 | −8.89 | ⊚ | −12 | 14.8 | ◯ | ◯ |
| 8 | 0.381 | 0.364 | 0.745 | Bi | 2 | 807 | 680 | −15.7 | Δ | −7.1 | 23.3 | Δ | Δ |
| 9 | 0.325 | 0.04 | 0.463 | — | — | 1208 | 1031 | −14.7 | ◯ | −11 | 17.6 | Δ | Δ |
| 10 | 0.025 | 0.333 | 0.404 | — | — | 770 | 709 | −7.92 | ⊚ | −14 | 21.1 | Δ | Δ |
| 11 | 0.032 | 0.013 | 0.045 | — | — | 1093 | 904 | −17.3 | Δ | −4.5 | 5.6 | ⊚ | Δ |

The cross section of the obtained multilayer ceramic capacitor was polished until the internal electrode layers were exposed, and the dielectric layer between the internal electrode layers was photographed using an FE-SEM BSE image at a magnification that allowed 200 to 400 grains to fit in one field of view. The number of grains in the obtained image was counted, and the average abundance ratio α of the core primarily composed of bismuth, sodium, and titanium and the average abundance ratio β of the core primarily composed of sodium and niobium were calculated.

For DC bias characteristics, if the rate of change when an SC bias of 15 V/μm was applied was within −14%, it was judged as very good (double circle); if it was greater than −14% and less than −15%, it was judged as good (circle); and if it exceeded −15%, it was judged as fair (triangle).

With regard to temperature characteristics, if the minimum and maximum rate of change at 1 Vrms, −55° C. to +150° C., and frequencies of 0.1 kHz, 1 kHz, 10 kHz, 100 kHz, and 1000 kHz was within ±10%, it was judged as very good (double circle); if it was within ±15%, it was judged as good (circle); and if it was ±15% or more, it was judged as fair (triangle).

The results in Table 1 show that the differences in the main components of the first core 411 and the second core 421 result in differences in multiple characteristics, such as DC bias characteristics and temperature characteristics.

Furthermore, as shown in Table 1, the dielectric ceramic compositions of Examples 1 to 7, where 0.05≤α≤0.35, 0.05≤β≤0.35, and 0.1≤γ≤0.7, exhibited a capacitance change rate of 15% or less when a DC bias of 15 V/μm was applied, and a capacitance change rate of ±15% or less in the temperature range of −55° C. to 150° C. Examples 1 to 7 demonstrate that the temperature and bias characteristics deteriorate as the proportion of cores primarily composed of bismuth, sodium, and titanium and cores primarily composed of sodium and niobium increases. Furthermore, a high proportion of cores primarily composed of bismuth, sodium, and titanium results in a high dielectric constant and poor bias and temperature characteristics, while a high proportion of cores primarily composed of sodium and niobium results in a low dielectric constant and poor temperature characteristics. From the above results, it is clear that it is more preferable that 0.092<α<0.348, 0.115<β<0.333, and 0.247<γ<0.637.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
a dielectric layer including: a first dielectric grain having a first core containing bismuth, sodium, and titanium as a main component and a first shell provided outside of the first core; and a second dielectric grain having a second core containing sodium and niobium as a main component and a second shell provided outside of the second core;
a plurality of internal electrodes facing each other and sandwiching the dielectric layer; and
external electrodes electrically connected to the plurality of internal electrodes respectively.

2. The multilayer ceramic electronic device as claimed in claim 1,
wherein, when an average abundance ratio of the first dielectric grain in the dielectric layer is α and an average abundance ratio of the second dielectric grain in the dielectric layer is β, following conditions are satisfied: 0.05≤α≤0.35, 0.05≤β≤0.35, and 0.1≤α+β≤0.70.

3. The multilayer ceramic electronic device as claimed in claim 1,
wherein, when an image of a cross section of the dielectric layer is captured with a field emission scanning electron microscope so that 200 to 400 dielectric grains are visible within a field of view, an average abundance ratio of the first dielectric grain is α, and an average abundance ratio of the second dielectric grain is β, following conditions are satisfied: 0.05≤α≤0.35 and 0.05≤β≤0.35.

4. The multilayer ceramic electronic device as claimed in claim 1,
wherein, when an average abundance ratio of the first dielectric grain in the dielectric layer is α and an average abundance ratio of the second dielectric grain in the dielectric layer is β, following conditions are satisfied: 0.092<α<0.348, 0.115<β<0.333, and 0.247<α+β<0.637.

5. The multilayer ceramic electronic device as claimed in claim 1,
wherein a capacitance change rate when a DC bias of 15 V/μm is applied is within 15%, and the capacitance change rate in a temperature range of −55° C. to 150° C. is ±15% or less.

6. The multilayer ceramic electronic device as claimed in claim 1,
wherein, in the dielectric layer, when an elemental ratio of titanium to niobium is Ti/Nb=X, 0.8≤X≤5.7 is satisfied.

7. The multilayer ceramic electronic device as claimed in claim 1, wherein the first shell and the second shell contain bismuth, sodium, titanium, and niobium as a main component.

8. The multilayer ceramic electronic device as claimed in claim 1, wherein the first shell and the second shell have same constituent components.

9. A dielectric ceramic composition comprising:
a first dielectric grain having a first core containing bismuth, sodium, and titanium as a main component and a first shell provided outside of the first core; and
a second dielectric grain having a second core containing sodium and niobium as a main component and a second shell provided outside of the second core.

10. A dielectric ceramic composition comprising:
a first dielectric grain having a first core and a first shell provided outside of the first core; and
a second dielectric grain having a different constituent component from the first core and a second shell provided outside of the second core.
